(19) United States
(12) Patent Application Publication
(10) Pub. No.: US 2026/0175890 A1
(43) Pub. Date: Jun. 25, 2026

(54) MULTI-FUNCTIONAL CART FRAME OF OUTDOOR CART

(71) Applicant: Wuyi Migo Leisure Products Co., Ltd., Jinhua (CN)

(72) Inventor: Peiwu WU, Wuhu (CN)

(73) Assignee: Wuyi Migo Leisure Products Co., Ltd., Jinhua (CN)

(21) Appl. No.: 19/098,450

(22) Filed: Apr. 2, 2025

(30) Foreign Application Priority Data
Dec. 20, 2024 (CN) 2024118927222

(51) Int. Cl. B62B 3/02

(52) U.S. Cl. CPC B62B 3/025

(57) ABSTRACT

The present invention discloses a multi-functional cart frame of an outdoor cart, including a cart frame body and a movable frame. The cart frame body includes a bottom frame, a first side frame, a second side frame, a third side frame, and a fourth side frame. The movable frame includes a first seating frame, a second seating frame, and a bridge frame. The first seating frame can be folded and positioned on the first side frame, and the second seating frame can be folded and positioned on the second side frame. In an unfolded state, a first storage layer arranged between the bottom frame and the movable frame and a second storage layer arranged on an upper side of the movable frame are formed between the third side frame and the fourth side frame.

### CROSS-REFERENCE TO RELATED APPLICATIONS

The application claims priority to Chinese patent application No. 2024118927222, filed on Dec. 20, 2024, the entire contents of which are incorporated herein by reference.

### TECHNICAL FIELD

The present invention relates to the technical field of outdoor carts, and in particular, to a multi-functional cart frame of an outdoor cart.

### BACKGROUND

An outdoor cart is a tool that can be used to transport items, and with the development of the economy, people have an increasing demand for the multi-functionality of the outdoor cart. For cart frames of outdoor carts on the market currently, for example, a cart frame of an outdoor cart disclosed in the invention patent with publication No. CN103287471A, the cart frame of an outdoor cart includes a bottom framework, an upper edge U framework, a front edge U framework, a handrail U framework, a support U framework, a front rolling wheel, and a rear rolling wheel. The rear rolling wheel is mounted on a rear portion of the bottom framework, the front rolling wheel is mounted on a cross beam of the support U framework, and the cross beam of the support U framework can support a front portion of the bottom framework. Two ends of the handrail U framework are hinged to two sides of the rear portion of the bottom framework respectively, and a middle portion thereof is hinged to two sides of a rear portion of the upper edge U framework. Middle portions of two sides of the front edge U framework and the support U framework are crossed and hinged to each other, two ends of the front edge U framework are hinged to two sides of a middle portion of the bottom framework respectively, and two ends of the support U framework are hinged to two ends of a front portion of the upper edge U framework respectively. The cart frame of an outdoor cart in this technical solution is only used for single-layer loading, has a single function, is not applicable to some conditions requiring layered loading, does not have a seating function, and is inconvenient for taking children out for fun.

### SUMMARY

In view of deficiencies in the prior art, the present invention provides a multi-functional cart frame of an outdoor cart, which has three use modes: a single-layer loading mode, a dual-layer loading mode, and a person seating mode, has more diverse functions, can be randomly switched between different modes as required, is flexible and convenient to use, and is very practical.

The present invention provides a multi-functional cart frame of an outdoor cart, including a cart frame body and a movable frame. The cart frame body includes a bottom frame, a first side frame and a second side frame that are arranged on two sides of the bottom frame along a length direction, and a third side frame and a fourth side frame that are arranged on two sides of the bottom frame along a width direction, the first side frame and the second side frame respectively include two bearing vertical rods that are arranged oppositely, and two ends of each of the third side frame and the fourth side frame are connected to the first side frame and the second side frame respectively; the movable frame is arranged above the bottom frame in a spaced manner, and the movable frame includes a first seating frame hinged to the first side frame, a second seating frame hinged to the second side frame, and a bridge frame arranged between the first seating frame and the second seating frame; the first seating frame can be folded and positioned on the first side frame, and the second seating frame can be folded and positioned on the second side frame; the bridge frame has an unfolded state in which the bridge frame is connected to the first seating frame and the second seating frame respectively and an accommodated state in which the bridge frame is separated from the first seating frame and/or the second seating frame; in the unfolded state, a first storage layer arranged between the bottom frame and the movable frame and a second storage layer arranged on an upper side of the movable frame are formed between the third side frame and the fourth side frame; and in the accommodated state, a seating region arranged along the first seating frame, the second seating frame, and the bottom frame is formed between the third side frame and the fourth side frame.

Preferably, one end of the bridge frame is hinged to the first seating frame and can rotate to be stacked and accommodated on an upper side of the first seating frame, and the other end thereof is separably connected to the second seating frame.

Preferably, a first support portion that protrudes towards an interior of the cart frame body and is configured to bear the bridge frame is disposed on the second seating frame, a hanging portion arranged corresponding to the first support portion is disposed on the bridge frame, and the bridge frame rests on the first support portion through the hanging portion to be separably connected to the second seating frame.

Preferably, the first seating frame is hinged to the first side frame through a first hinge shaft, a first flipping region allowing the first seating frame and the bridge frame to flip and fold upwards around an axis of the first hinge shaft is formed between the third side frame and the fourth side frame, and a first positioning member configured to position the first seating frame after flipping and folding is disposed on an upper portion of the first side frame or upper portions of the third side frame and the fourth side frame; and

the second seating frame is hinged to the second side frame through a second hinge shaft, a second flipping region allowing the second seating frame to flip and fold upwards around the second hinge shaft is formed between the third side frame and the fourth side frame, and a second positioning member configured to position the second seating frame after flipping and folding is disposed on an upper portion of the second side frame or the upper portions of the third side frame and the fourth side frame.

Preferably, the first positioning member includes a positioning clamping groove I and a positioning clamping groove III arranged back to the positioning clamping groove I, a groove opening of the positioning clamping groove I is arranged towards an interior of the cart frame body, a groove opening of the positioning clamping groove III is arranged towards an exterior of the cart frame body, the positioning clamping groove I is internally provided with a positioning channel I configured to be connected to the first seating frame in a clamping manner, and the positioning clamping groove III is internally provided with a positioning channel III configured to be connected to the bridge frame in a clamping manner;

the second positioning member includes a positioning clamping groove II, a groove opening of the positioning clamping groove II is arranged towards the interior of the cart frame body, and the positioning clamping groove II is internally provided with a positioning channel II configured to be connected to the second seating frame in a clamping manner; and

the positioning channel I, the positioning channel II, and the positioning channel

III are arranged in parallel to the bearing vertical rod.

Preferably, the two ends of each of the third side frame and the fourth side frame respectively include a first handrail transverse rod connected to the upper portion of the first side frame and a second handrail transverse rod connected to the upper portion of the second side frame, the first handrail transverse rod and the second handrail transverse rod are arranged above the first seating frame and the second seating frame respectively, and the first handrail transverse rod and the second handrail transverse rod are arranged on two sides of the seating region respectively for an occupant to rest a hand when seating in the seating region.

Preferably, the first seating frame is connected to the first handrail transverse rod through a cantilever member, an upper end of the cantilever member is hung on the handrail transverse rod, the first seating frame is hung at a lower end of the cantilever member, and the cantilever member is separably connected to the first handrail transverse rod and/or the first seating frame through a hooking structure.

Preferably, the first handrail transverse rod is provided with a first connecting shaft and a second connecting shaft, and the second connecting shaft is arranged on one side, close to the first side frame, of the first connecting shaft in a spaced manner; and

one end of the cantilever member is hinged to the first seating frame, and the other end thereof is hinged to the first connecting shaft and forms a first polygonal linkage structure with the first handrail transverse rod, the first side frame, and the first seating frame before the first seating frame is folded and positioned, and can be connected to the second connecting shaft in a positioning manner and form a triangular support structure with the first handrail transverse rod and the first seating frame after the first seating frame is folded and positioned.

Preferably, the third side frame and the fourth side frame respectively include at least one group of a first crossed rod and a second crossed rod that are hinged to each other, and the first crossed rod is arranged on an inner side of the second crossed rod; one end of the first handrail transverse rod is hinged to the first side frame, and the other end thereof is hinged to an upper end of the first crossed rod; one end of the second handrail transverse rod is hinged to the second side frame, and the other end thereof is hinged to an upper end of the second crossed rod; and the second seating frame is separably lap-jointed to the first crossed rod through a lap-joint member.

Preferably, the first crossed rod is provided with a third connecting shaft, and the second handrail transverse rod is provided with a fourth connecting shaft;
a lower end of the first crossed rod is hinged to a lower portion of the second side frame or the bottom frame; and
a linkage arm is further included, the linkage arm is separably connected to the first crossed rod and/or the second seating frame through a hooking structure, one end of the linkage arm is hinged to the second seating frame, and the other end thereof is hinged to the third connecting shaft and forms a second polygonal linkage structure with the first crossed rod, the second side frame, and the second seating frame or forms a second polygonal linkage structure with the first crossed rod, the second side frame, the bottom frame, and the second seating frame before the second seating frame is folded and positioned, and can be connected to the fourth connecting shaft in a positioning manner and form a triangular support structure with the second handrail transverse rod and the second seating frame after the second seating frame is folded and positioned.

The present invention provides the multi-functional cart frame of an outdoor cart. The movable frame is disposed, the movable frame is arranged above the bottom frame in a spaced manner, and the movable frame includes the first seating frame hinged to the first side frame, the second seating frame hinged to the second side frame, and the bridge frame arranged between the first seating frame and the second seating frame. The first seating frame can be folded and positioned on the first side frame, and the second seating frame can be folded and positioned on the second side frame. The bridge frame has the unfolded state in which the bridge frame is connected to the first seating frame and the second seating frame respectively and the accommodated state in which the bridge frame is separated from the first seating frame and/or the second seating frame. In the unfolded state, the first storage layer arranged between the bottom frame and the movable frame and the second storage layer arranged on the upper side of the movable frame are formed between the third side frame and the fourth side frame, so that the cart frame of an outdoor cart has a layered loading function, and items can be classified and stored after shopping, thereby facilitating classified storage and taking. In the accommodated state, the seating region arranged along the first seating frame, the second seating frame, and the bottom frame is formed between the third side frame and the fourth side frame, so that the cart frame of an outdoor cart has a person seating function, a child can be carried in the seating region, and the child can seat on the first seating frame, the second seating frame, or the folded bridge frame, which is more comfortable in seating experience, thereby facilitating taking the child out for fun. When the first seating frame is folded and positioned on the first side frame, and the second seating frame is folded and positioned on the second side frame, the cart frame of an outdoor cart has a single-layer loading function. Therefore, the cart frame of an outdoor cart has three use modes: a single-layer loading mode, a dual-layer loading mode, and a person seating mode, which has more diverse functions, can be operated to be randomly switched between different modes according to a requirement by rotating the first seating frame relative to the first side frame, or rotating the second seating frame relative to the second side frame, and unfolding or accommodating the bridge frame relative to the first seating frame and the second seating frame, is flexible and convenient to use, and is very practical.

The additional advantages of the present invention will be partially presented in the following description, some of which will become apparent from the following description, or learned through practice of the present invention.

### BRIEF DESCRIPTION OF THE DRAWINGS

The accompanying drawings described herein are intended for a further understanding of the present invention and constitute a part of the present application.

Example embodiments of the present invention and descriptions thereof are intended to explain the present invention, and do not constitute any inappropriate limitation on the present invention. In the accompanying drawings:

FIG. 1 is a schematic structural diagram of a cart frame of an outdoor cart under a dual-layer loading mode according to a first embodiment of the present invention;

FIG. 2 is a schematic structural diagram of a cart frame of an outdoor cart in a half-folded state under a dual-layer loading mode according to a first embodiment of the present invention;

FIG. 3 is a schematic structural diagram of a cart frame of an outdoor cart in a fully-folded state under a dual-layer loading mode according to a first embodiment of the present invention;

FIG. 4 is a schematic structural diagram of a cart frame of an outdoor cart under a single-layer loading mode according to a first embodiment of the present invention;

FIG. 5 is a schematic structural diagram of a cart frame of an outdoor cart in a fully-folded state under a single-layer loading mode according to a first embodiment of the present invention;

FIG. 6 is a schematic structural diagram of a cart frame of an outdoor cart under a person seating mode according to a first embodiment of the present invention;

FIG. 7 is a schematic structural diagram of a cart frame of an outdoor cart in a fully-folded state under a person seating mode according to a first embodiment of the present invention;

FIG. 8 is an exploded view of a cart frame of an outdoor cart according to a first embodiment of the present invention;

FIG. 9 is a partial enlarged view of a position A in FIG. 4;

FIG. 10 is a partial enlarged view of a position B in FIG. 4;

FIG. 11 is a schematic structural diagram of a lap-joint member according to a first embodiment of the present invention;

FIG. 12 is a schematic structural diagram of a hooking structure according to a first embodiment of the present invention;

FIG. 13 is a schematic structural diagram of a cart frame of an outdoor cart under a dual-layer loading mode according to a second embodiment of the present invention;

FIG. 14 is a schematic structural diagram of a cart frame of an outdoor cart under a person seating mode according to a second embodiment of the present invention;

FIG. 15 is a schematic structural diagram of a cart frame of an outdoor cart under a single-layer loading mode according to a second embodiment of the present invention;

FIG. 16 is a schematic structural diagram of a cantilever member according to a second embodiment of the present invention; and

FIG. 17 is a schematic structural diagram of a linkage arm according to a second embodiment of the present invention.

Reference numerals in the accompanying drawings: cart frame body 1; bottom frame 2; first side frame 3; second side frame 4; third side frame 5; fourth side frame 6; cantilever member 7; lap-joint member 8; linkage arm 9; movable frame 21; first seating frame 22; second seating frame 23; bridge frame 24; first storage layer 211; second storage layer 212; seating region 213; first support portion 221; fifth connecting shaft 222; fifth limiting head 223; sixth connecting shaft 231; sixth limiting head 232; hanging portion 241; bearing vertical rod 31; first hinge shaft 32; the first positioning member 33; first handrail transverse rod 34; positioning clamping groove I 331; positioning clamping groove III 332; positioning channel I 333; positioning channel III 334; first connecting shaft 341; second connecting shaft 342; first limiting head 343; second limiting head 344; second hinge shaft 42; second positioning member 43; second handrail transverse rod 44; positioning clamping groove II 431; positioning channel II 432; fourth connecting shaft 441; fourth limiting head 442; first crossed rod 51; second crossed rod 52; third connecting shaft 511; third limiting head 512; first opening groove 71; second opening groove 72; first detachable hanging portion 73; second detachable hanging portion 74; third detachable hanging portion 75; fourth detachable hanging portion 76; bending hook portion 711; opening portion 712; first hanging hole 731; second hanging hole 732; first transition opening 733; third hanging hole 741; fourth hanging hole 742; second transition opening 743; fifth hanging hole 751; sixth hanging hole 752; third transition opening 753; seventh hanging hole 761; eighth hanging hole 762; fourth transition opening 763; lap-joint base 81; lap-joint portion 82; lap-joint groove 83.

### DETAILED DESCRIPTION OF THE EMBODIMENTS

To make the purpose, technical solutions, and advantages of the embodiments of the present invention clearer, the following clearly and completely describes the technical solutions of the embodiments of the present invention with reference to the accompanying drawings in the embodiments of the present invention. Apparently, the embodiments described are a part rather than all of the embodiments of the present invention. All other embodiments obtained by those of ordinary skill in the art based on the described embodiments of the present invention without creative efforts shall fall within the protection scope of the present invention.

In the description of the present invention, it should be understood that the orientations or positional relationships indicated by the terms “upper”, “lower”, “front”, “rear”, “left”, “right”, “top”, “bottom”, “inner”, “outer”, and the like are in accordance with those shown in the accompanying drawings, and are intended only for the convenience of describing the present invention and simplifying the description rather than for indicating or implying that the referred devices or elements must be provided with a particular orientation or constructed or operated in a particular orientation; and therefore, these terms should not be construed as limiting the present invention.

In the present invention, unless otherwise explicitly specified and limited, the terms “mounted”, “attached”, “connected”, “fixed”, and the like should be understood in a broad sense, for example, it may be a fixed connection, a detachable connection or an integral connection; it may be a mechanical connection or an electrical connection; it may be a direct attachment, or an indirect attachment through an intermediate medium; and it may be a communication within two elements. For those of ordinary skill in the art, the specific meanings of the above terms in the present invention can be understood on a case-by-case basis.

In the present invention, unless otherwise expressly specified and defined, a first feature being “above” or “below” a second feature may include not only direct contact between the first and second features but also indirect contact between the first and second features via another feature between them. Furthermore, that the first feature is “over”, “above”, or “on” the second feature includes that the first feature is directly above and diagonally above the second feature, or merely means that the first feature is higher in level than the second feature. That the first feature is “beneath”, “below”, or “under” the second feature includes that the first feature is directly below and diagonally below the second feature, or merely means that the first feature is lower in level than the second feature.

Unless otherwise defined, the technical or scientific terms used herein shall have the common meanings as understood by those of ordinary skill in the art to which the present invention belongs. The terms “first”, “second”, and the like used in the description and claims of the present invention patent application are not intended to indicate any sequence, quantity or importance, but are only used to distinguish different components. Similarly, similar words such as “one” or “a/an” do not indicate a quantity limitation, but indicate that there is at least one.

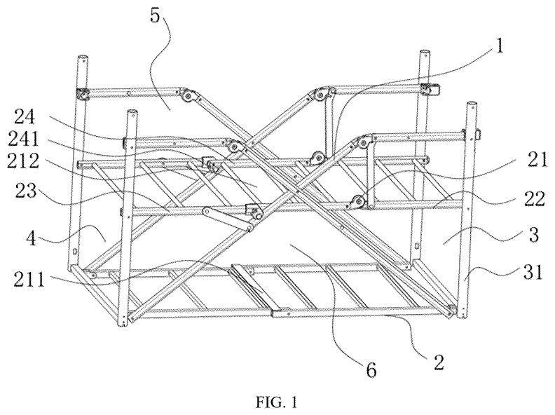

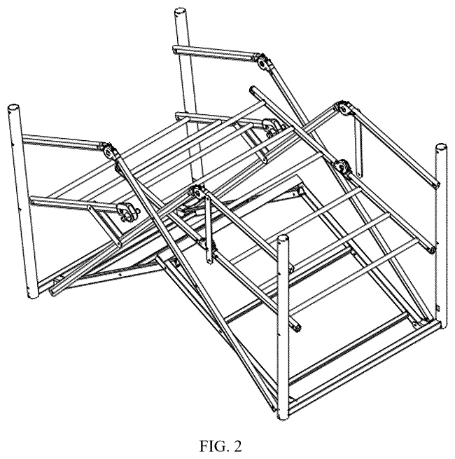

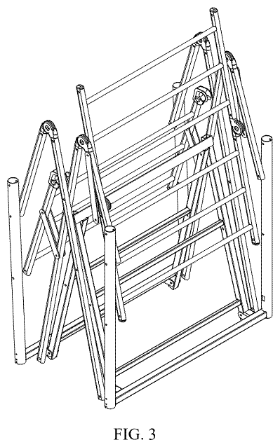

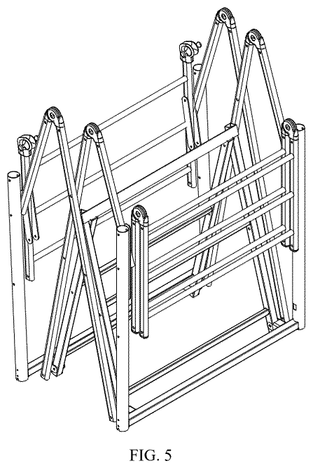

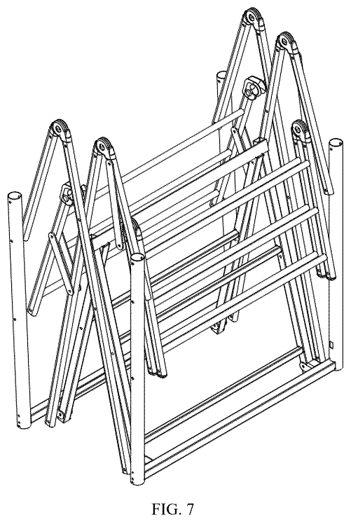

As shown in FIG. 1 to FIG. 12, as a first embodiment of the present invention, a multi-functional cart frame of an outdoor cart is provided and includes a cart frame body 1 and a movable frame 21. The cart frame body 1 includes a bottom frame 2, a first side frame 3 and a second side frame 4 that are arranged on two sides of the bottom frame 2 along a length direction, and a third side frame 5 and a fourth side frame 6 that are arranged on two sides of the bottom frame 2 along a width direction. The first side frame and the second side frame respectively include two bearing vertical rods 31 that are arranged oppositely, and two ends of each of the third side frame and the fourth side frame are connected to the first side frame and the second side frame respectively. The movable frame 21 is arranged above the bottom frame 2 in a spaced manner, and the movable frame 21 includes a first seating frame 22 hinged to the first side frame 3, a second seating frame 23 hinged to the second side frame 4, and a bridge frame 24 arranged between the first seating frame 22 and the second seating frame 23. The first seating frame 22 can be folded and positioned on the first side frame 3, and the second seating frame 23 can be folded and positioned on the second side frame 4. The bridge frame 24 has an unfolded state in which the bridge frame is connected to the first seating frame 22 and the second seating frame 23 respectively and an accommodated state in which the bridge frame is separated from the second seating frame 23. In the unfolded state, a first storage layer 211 arranged between the bottom frame 2 and the movable frame 21 and a second storage layer 212 arranged on an upper side of the movable frame 21 are formed between the third side frame and the fourth side frame, so that the cart frame of an outdoor cart has a layered loading function, and items can be classified and stored after shopping, thereby facilitating classified storage and taking. In the accommodated state, a seating region 213 arranged along the first seating frame 22, the second seating frame 23, and the bottom frame 2 is formed between the third side frame and the fourth side frame, so that the cart frame of an outdoor cart has a person seating function, a child can be carried in the seating region 213, and the child can seat on the first seating frame 22, the second seating frame 23, or the folded bridge frame 24, which is more comfortable in seating experience, thereby facilitating taking the child out for fun. When the first seating frame 22 is folded and positioned on the first side frame 3, and the second seating frame 23 is folded and positioned on the second side frame 4, the cart frame of an outdoor cart has a single-layer loading function. Therefore, the cart frame of an outdoor cart has three use modes: a single-layer loading mode, a dual-layer loading mode, and a person seating mode, which has more diverse functions, can be operated to be randomly switched between different modes according to a requirement by rotating the first seating frame 22 relative to the first side frame 3, or rotating the second seating frame 23 relative to the second side frame 4, and unfolding or accommodating the bridge frame 24 relative to the first seating frame and the second seating frame, is flexible and convenient to use, and is very practical. In some other embodiments, the bridge frame 24 can also be disposed to have the unfolded state in which the bridge frame is connected to the first seating frame 22 and the second seating frame 23 respectively and an accommodated state in which the bridge frame is separated from the first seating frame 22, or disposed to have the unfolded state in which the bridge frame is connected to the first seating frame 22 and the second seating frame 23 respectively and an accommodated state in which the bridge frame is separated from both the first seating frame 22 and the second seating frame 23, so that the bridge frame 24 may be taken out separately and may be placed on the first storage layer 211 or the second storage layer 212 or at home when not needed, to facilitate seating.

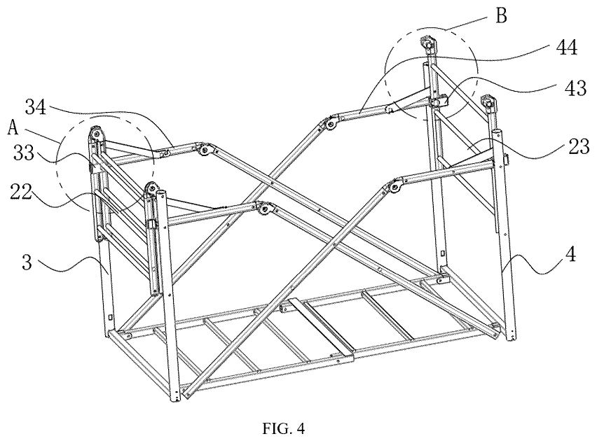

As shown in FIG. 1 and FIG. 4, one end of the bridge frame 24 is hinged to the first seating frame 22 and can rotate to be stacked and accommodated on an upper side of the first seating frame 22, and the other end thereof is separably connected to the second seating frame 23. After flipping through hinging at one end, the bridge frame is separated from the second seating frame 23 and is converted into the accommodated state.

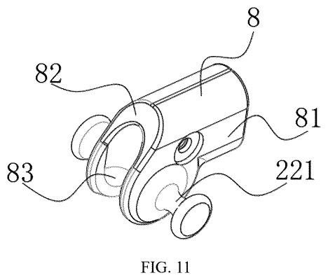

As shown in FIG. 1 and FIG. 11, a first support portion 221 that protrudes towards the interior of the cart frame body 1 and is configured to bear the bridge frame 24 is disposed on the second seating frame 23. A hanging portion 241 arranged corresponding to the first support portion 221 is disposed on the bridge frame 24. The bridge frame 24 rests on the first support portion 221 through the hanging portion 241 to be separably connected to the second seating frame 23. Through a connection between the first support portion 221 and the hanging portion 241, separation and flipping of the bridge frame 24 may be implemented more quickly, thereby reducing time for changing a use mode of the outdoor cart during use, enhancing fixing strength between the bridge frame 24 and the second seating frame 23 during unfolding, and increasing a bearing capability of the bridge frame 24, so that a structural connection of the whole cart in the unfolded state is more stable and compact.

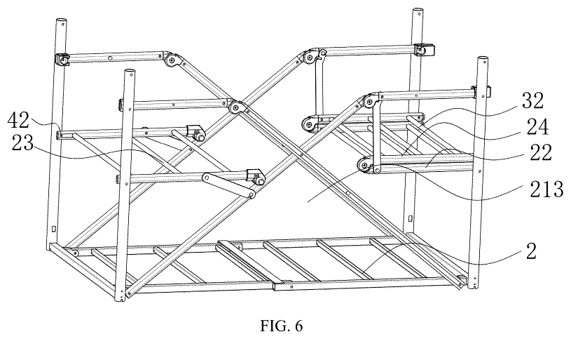

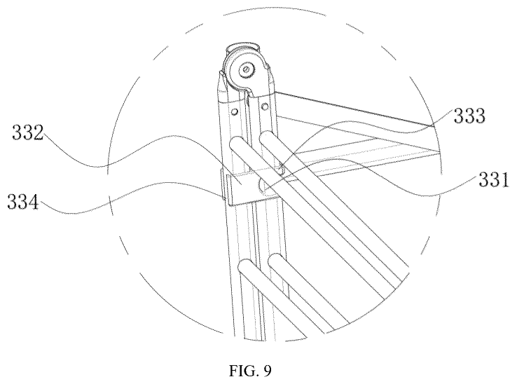

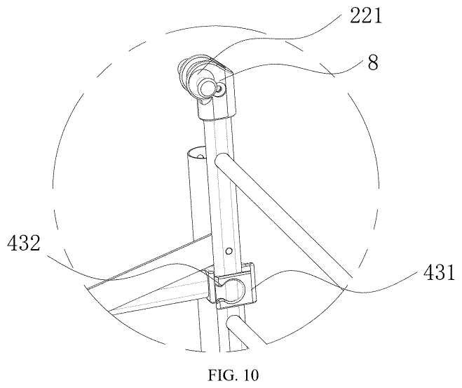

As shown in FIG. 1, FIG. 4, FIG. 6, FIG. 9, and FIG. 10, the first seating frame 22 is hinged to the first side frame 3 through a first hinge shaft 32, a first flipping region allowing the first seating frame 22 and the bridge frame 24 to flip and fold upwards around an axis of the first hinge shaft 32 is formed between the third side frame and the fourth side frame, and a first positioning member 33 configured to position the first seating frame 22 after flipping and folding is disposed on an upper portion of the first side frame 3 or upper portions of the third side frame and the fourth side frame. The second seating frame 23 is hinged to the second side frame 4 through a second hinge shaft 42, a second flipping region allowing the second seating frame 23 to flip and fold upwards around the second hinge shaft 42 is formed between the third side frame and the fourth side frame, and a second positioning member 43 configured to position the second seating frame 23 after flipping and folding is disposed on an upper portion of the second side frame 4 or the upper portions of the third side frame and the fourth side frame. The seating frames are fixed through the first positioning member and the second positioning member, so that the seating frames do not fall in the cart frame during use. After a cloth cover is sleeved on the whole cart, the seating frames are flipped to change to the single-layer loading mode with large space in the whole cart, and large items may be loaded.

As shown in FIG. 9 and FIG. 10, the first positioning member 33 includes a positioning clamping groove I 331 and a positioning clamping groove III 332 arranged back to the positioning clamping groove I 331. A groove opening of the positioning clamping groove I 331 is arranged towards the interior of the cart frame body 1, and a groove opening of the positioning clamping groove III 332 is arranged towards the exterior of the cart frame body 1. The positioning clamping groove I 331 is internally provided with a positioning channel I 333 configured to be connected to the first seating frame 22 in a clamping manner, and the positioning clamping groove III 332 is internally provided with a positioning channel III 334 configured to be connected to the bridge frame 24 in a clamping manner. The second positioning member 43 includes a positioning clamping groove II 431, a groove opening of the positioning clamping groove II 431 is arranged towards the interior of the cart frame body 1, and the positioning clamping groove II 431 is internally provided with a positioning channel II 432 configured to be connected to the second seating frame 23 in a clamping manner. The positioning channel I 333, the positioning channel II 432, and the positioning channel III 334 are arranged in parallel to the bearing vertical rod 31 and are arranged in a vertical direction. Through clamping between the positioning channels and the positioning clamping grooves, fixing strength of the seating frames and the bridge frame 24 after flipping and folding is ensured, and structures are stable.

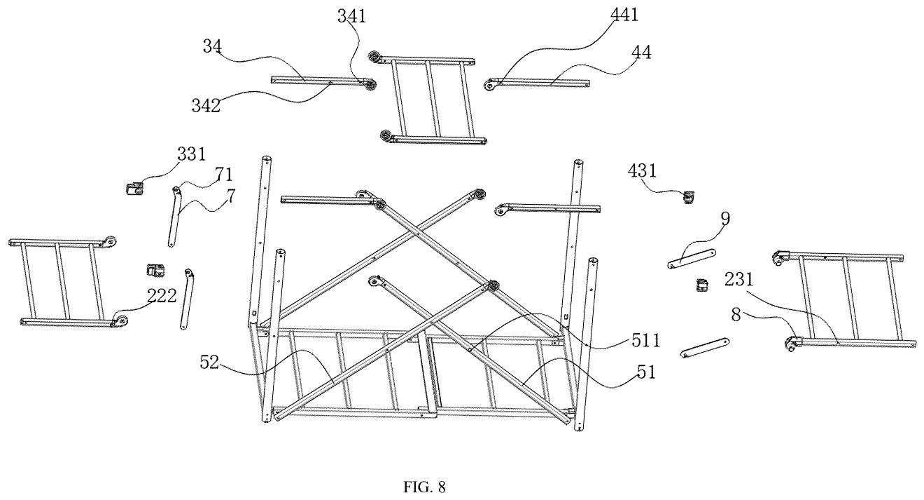

As shown in FIG. 8, the two ends of each of the third side frame and the fourth side frame respectively include a first handrail transverse rod 34 connected to the upper portion of the first side frame 3 and a second handrail transverse rod 44 connected to the upper portion of the second side frame 4. The first handrail transverse rod and the second handrail transverse rod are arranged above the first seating frame and the second seating frame respectively, and the first handrail transverse rod and the second handrail transverse rod are arranged on two sides of the seating region 213 respectively for an occupant to rest a hand when seating in the seating region 213, thereby enhancing seating experience of the child during seating, conforming to ergonomics, and increasing practicability.

As shown in FIG. 1 and FIG. 4, the first seating frame 22 is connected to the first handrail transverse rod 34 through a cantilever member 7, an upper end of the cantilever member 7 is hung on the handrail transverse rod, the first seating frame 22 is hung at a lower end of the cantilever member 7, and the cantilever member 7 is separably connected to the first handrail transverse rod 34 or the first seating frame 22 through a hooking structure.

As shown in FIG. 1, FIG. 4, and FIG. 8, the first handrail transverse rod 34 is provided with a first connecting shaft 341 and a second connecting shaft 342. The second connecting shaft 342 is arranged on one side, close to the first side frame 3, of the first connecting shaft 341 in a spaced manner. One end of the cantilever member 7 is hinged to the first seating frame 22, and the other end thereof is hinged to the first connecting shaft 341 and forms a first polygonal linkage structure with the first handrail transverse rod 34, the first side frame 3, and the first seating frame 22 before the first seating frame 22 is folded and positioned, and can be connected to the second connecting shaft 342 in a positioning manner and form a triangular support structure with the first handrail transverse rod 34 and the first seating frame 22 after the first seating frame 22 is folded and positioned. Through the first polygonal linkage structure formed by the cantilever member 7 when the seating frames are unfolded, a quick folding function of the cart frame may be implemented. By adjusting the handrail transverse rod, the cantilever member 7 may drive the seating frames, and after the seating frames are flipped and folded, the cantilever member 7 performs secondary support on positioned seating frames, thereby enhancing structural stability.

As shown in FIG. 8 and FIG. 11, the third side frame and the fourth side frame respectively include at least one group of a first crossed rod 51 and a second crossed rod 52 that are hinged to each other, and the first crossed rod 51 is arranged on an inner side of the second crossed rod 52. One end of the first handrail transverse rod 34 is hinged to the first side frame 3, and the other end thereof is hinged to an upper end of the first crossed rod 51. One end of the second handrail transverse rod 44 is hinged to the second side frame 4, and the other end thereof is hinged to an upper end of the second crossed rod 52. The second seating frame 23 is separably lap-jointed to the first crossed rod 51 through a lap-joint member 8. The lap-joint member 8 may be disposed on the second seating frame 23 or the first crossed rod 51. The second seating frame 23 is separably lap-jointed on the lap-joint member 8, to fix the second seating frame 23. The lap-joint member 8 includes a lap-joint base 81 and a lap-joint portion 82 connected to the lap-joint base 81. The lap-joint base 81 is connected to the first seating frame 22, and a lap-joint groove 83 concavely and convexly matched with the first crossed rod 51 is formed on a bottom surface of the lap-joint portion 82 in a concave manner. Through radian matching between the lap-joint groove 83 and the first crossed rod 51, the first support portion 221 is specifically disposed at a position protruding from an inner side or an outer side of the lap-joint portion 82. The lap-joint member 8 fixes the second seating frame 23, to ensure stability of the bridge frame 24 connected to the second seating frame 23, enhance structural stability, and ensure a stronger bearing capability, so that when the bridge frame 24 is in the unfolded state, the whole cart may be converted into a dual-layer loading state, loaded items may be separated without interfering with each other, wet-dry separation and light-heavy separation may be performed outdoors or when shopping, to enhance the practicality of the whole cart. In addition, when the cloth cover is covered on the cart frame for use, the cloth covers outside the first side frame and the second side frame may be provided with upper and lower entry windows. The two entry windows do not interfere with each other, and the entry windows of the cloth covers may be opened independently for placement.

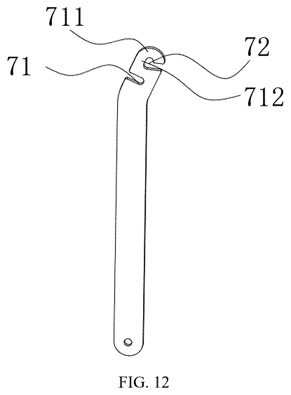

As shown in FIG. 8 and FIG. 12, the first crossed rod 51 is provided with a third connecting shaft 511, and the second handrail transverse rod 44 is provided with a fourth connecting shaft 441. A lower end of the first crossed rod 51 is hinged to a lower portion of the second side frame 4 or the bottom frame 2. A linkage arm 9 is further included, and the linkage arm 9 is separably connected to the first crossed rod 51 or the second seating frame 23 through a hooking structure. One end of the linkage arm 9 is hinged to the second seating frame 23, and the other end thereof is hinged to the third connecting shaft 511 and forms a second polygonal linkage structure with the first crossed rod 51, the second side frame 4, and the second seating frame 23 or forms a second polygonal linkage structure with the first crossed rod 51, the second side frame 4, the bottom frame 2, and the second seating frame 23 before the second seating frame 23 is folded and positioned, and can be connected to the fourth connecting shaft 441 in a positioning manner and form a triangular support structure with the second handrail transverse rod 44 and the second seating frame 23 after the second seating frame 23 is folded and positioned, to stably support the second seating frame 23. Both the linkage arm 9 and the cantilever member 7 are hooking structures. The hooking structure is provided with a first opening groove 71 connected to the first connecting shaft 341 and a second opening groove 72 connected to the second connecting shaft 342 respectively. The first opening groove 71 includes a bending hook portion 711 and an opening portion 712 communicated with the bending hook portion 711. The bending hook portion 711 hooks the first connecting shaft 341 and can rotate around the first connecting shaft 341. An inner diameter of the opening portion 712 is greater than a diameter of the first connecting shaft 341 and is less than an inner diameter of the bending hook portion 711, to allow the first connecting shaft 341 to move relative to the cantilever member 7 along a radial direction thereof to separate from or extend into the bending hook portion 711. The second opening groove 72 is disposed as a U-shaped groove. When the cantilever member 7 forms the triangular support structure with the first seating frame, the second seating frame, and the first handrail transverse rod 34 in an enclosed manner, a groove opening of the second opening groove 72 is arranged along a lower side of the cantilever member 7, and a groove opening of the first opening groove 71 is arranged along an upper side of the cantilever member 7.

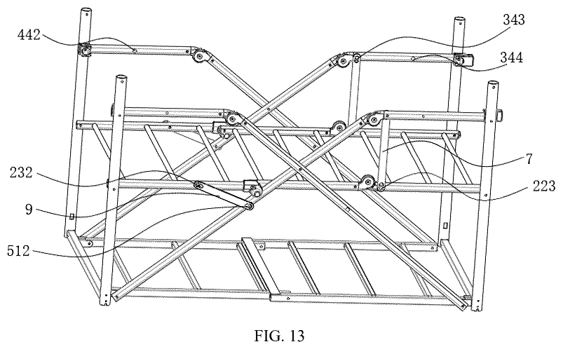

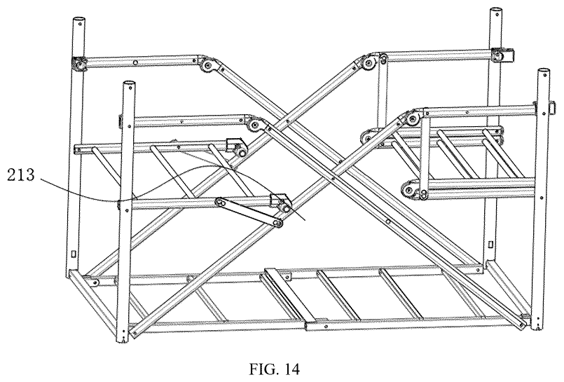

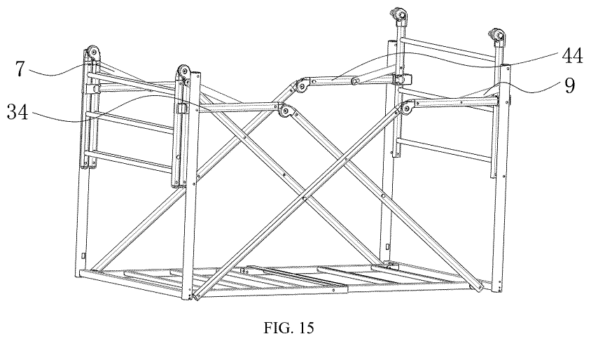

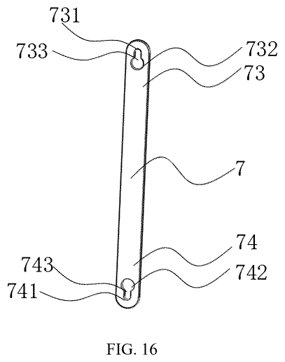

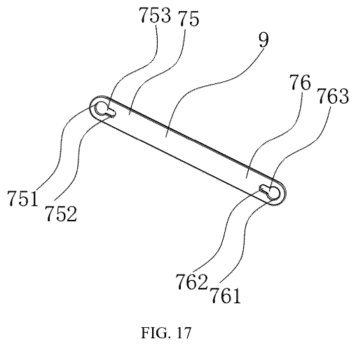

As shown in FIG. 13 to FIG. 17, as a second embodiment of the present invention, a multi-functional cart frame of an outdoor cart is further provided. A first seating frame 22 is connected to a first handrail transverse rod 34 through a cantilever member 7, an upper end of the cantilever member 7 is hung on the handrail transverse rod, the first seating frame 22 is hung at a lower end of the cantilever member 7, and the cantilever member 7 is separably connected to the first handrail transverse rod 34 and the first seating frame 22 through a detachable hanging structure.

As shown in FIG. 13 to FIG. 17, the first handrail transverse rod 34 is provided with a first connecting shaft 341 and a second connecting shaft 342, and the first seating frame 22 is provided with a fifth connecting shaft 222. An outer end of the first connecting shaft 341 is provided with a first limiting head 343, an outer end of the second connecting shaft 342 is provided with a second limiting head 344, and an outer end of the fifth connecting shaft 222 is provided with a fifth limiting head 223. The second connecting shaft 342 is arranged on one side, close to a first side frame 3, of the first connecting shaft 341 in a spaced manner. One end of the cantilever member 7 is snapped to the first seating frame 22 through the detachable hanging structure, and the other end thereof is snapped on the first connecting shaft 341 through the detachable hanging structure and forms a first polygonal linkage structure with the first handrail transverse rod 34, the first side frame 3, and the first seating frame 22 before the first seating frame 22 is folded and positioned. A first detachable hanging portion 73 includes a first hanging hole 731 and a second hanging hole 732 arranged on one side, close to a second detachable hanging portion 74, of the first hanging hole 731. The first hanging hole 731 is configured to hook the first connecting shaft 341 and can rotate around the first connecting shaft 341, and the second hanging hole 732 is configured to hook the second connecting shaft 342. An inner diameter of the second hanging hole 732 is greater than widths of the first limiting head 343 and the second limiting head 344 and is greater than an inner diameter of the first hanging hole 731, to allow the first connecting shaft 341 or the second connecting shaft 342 to move relative to the cantilever member 7 along an axial directly thereof to separate from or extend into the second hanging hole 732. The first hanging hole 731 is communicated with the second hanging hole 732 through a first transition opening 733. An inner diameter of the first transition opening 733 is greater than a diameter of the first connecting shaft 341, to allow the first connecting shaft 341 to move relative to the cantilever member 7 along a radial direction thereof to separate from or extend into the first hanging hole 731. A second detachable hanging portion 74 includes a third hanging hole 741 and a fourth hanging hole 742 arranged on one side, close to the first detachable hanging portion 73, of the third hanging hole 741. The third hanging hole 741 is configured to be detachably hung on a third connecting shaft 511 and can rotate around the third connecting shaft 511. An inner diameter of the fourth hanging hole 742 is greater than a width of a fifth limiting head 223 and is greater than an inner diameter of the third hanging hole 741, to allow the third connecting shaft 511 to move relative to the cantilever member 7 along an axial direction thereof to separate from or extend into the fourth hanging hole 742. The third hanging hole 741 is communicated with the fourth hanging hole 742 through a second transition opening 743. An inner diameter of the second transition opening 743 is greater than a diameter of the third connecting shaft 511, to allow the third connecting shaft 511 to move relative to the cantilever member 7 along a radial direction thereof to separate from or extend into the third hanging hole 741. When flipping and folding are needed, the linkage structure is pulled upwards, and the first limiting head and the second limiting head extend into the second hanging hole and the fourth hanging hole from the first hanging hole and the third hanging hole through the first transition opening and the second transition opening, so that the cantilever member 7 may be taken out. After the first seating frame 22 is folded and positioned, the cantilever member can be positioned and snapped on the second connecting shaft 342 through the first detachable hanging portion 73 and form a triangular support structure with the first handrail transverse rod 34 and the first seating frame 22.

As shown in FIG. 13 to FIG. 17, a first crossed rod 51 is provided with the third connecting shaft 511, a second handrail transverse rod 44 is provided with a fourth connecting shaft 441, and a second seating frame 23 is provided with a sixth connecting shaft 231. An outer end of the third connecting shaft 511 is provided with a third limiting head 512, an outer end of the fourth connecting shaft 441 is provided with a fourth limiting head 442, and an outer end of the sixth connecting shaft 231 is provided with a sixth limiting head 232. A lower end of the first crossed rod 51 is hinged to a lower portion of a second side frame 4 or a bottom frame 2. A linkage arm 9 is further included, and the linkage arm 9 is separably connected to the first crossed rod 51 and the second seating frame 23. One end of the linkage arm 9 is snapped to the second seating frame 23 through the detachable hanging structure, and the other end thereof is snapped on the third connecting shaft 511 through the detachable hanging structure and forms a second polygonal linkage structure with the first crossed rod 51, the second side frame 4, and the second seating frame 23 or forms a second polygonal linkage structure with the first crossed rod 51, the second side frame 4, the bottom frame 2, and the second seating frame 23 before the second seating frame 23 is folded and positioned. A third detachable hanging portion 75 includes a fifth hanging hole 751 and a sixth hanging hole 752 arranged on one side, close to a fourth detachable hanging portion 76, of the fifth hanging hole 751. The fifth hanging hole 751 is configured to be detachably hung on the sixth connecting shaft 231 and can rotate around the sixth connecting shaft 231, and the sixth hanging hole 752 is also configured to be detachably hung on the sixth connecting shaft 231. An inner diameter of the sixth hanging hole 752 is greater than widths of the third limiting head 512 and the fourth limiting head 442 and is less than an inner diameter of the fifth hanging hole 751, to allow the sixth connecting shaft 231 to move relative to the linkage arm 9 in an axial direction thereof to separate from or extend into the fifth hanging hole 751. The fifth hanging hole 751 is communicated with the sixth hanging hole 752 through a third transition opening 753. An inner diameter of the third transition opening 753 is greater than a diameter of the sixth connecting shaft 231, to allow the sixth connecting shaft 231 to move relative to the linkage arm 9 in a radial direction thereof to separate from or extend into the sixth hanging hole 752. The fourth detachable hanging portion 76 includes a seventh hanging hole 761 and an eighth hanging hole 762 arranged on one side, close to the third detachable hanging portion 75, of the seventh hanging hole 761, and the eighth hanging hole 762 is configured to be detachably hung on the third connecting shaft and the fourth connecting shaft. An inner diameter of the eighth hanging hole 762 is greater than widths of the third limiting head and the fourth limiting head and is less than an inner diameter of the eighth hanging hole 762, to allow the third connecting shaft and the fourth connecting shaft to move relative to the linkage arm 9 in axial directions thereof to separate from or extend into the eighth hanging hole 762. The seventh hanging hole 761 is communicated with the eighth hanging hole 762 through a fourth transition opening 763. An inner diameter of the fourth transition opening 763 is greater than diameters of the third connecting shaft and the fourth connecting shaft, to allow the third connecting shaft and the fourth connecting shaft to move relative to the linkage arm 9 in radial directions thereof to separate from or extend into the eighth hanging hole 762. When flipping and folding are needed, the second seating frame 23 is pulled upwards, and the third limiting head and the sixth limiting head extend into the fifth hanging hole and the seventh hanging hole from the sixth hanging hole and the eighth hanging hole through the third transition opening and the fourth transition opening, so that the linkage arm 9 may be taken out. The linkage arm can be connected to the fourth connecting shaft 441 in a positioning manner through the second detachable hanging portion 74 and form a triangular support structure with the second handrail transverse rod 44 and the second seating frame 23 after the second seating frame 23 is folded and positioned.

Finally, it should be noted that the above embodiments are only used to illustrate the technical solutions of the present invention rather than limiting thereto. Although the present invention has been described in detail with reference to the foregoing embodiments, those of ordinary skill in the art should understand that the technical solutions recited in the foregoing embodiments may still be modified, or some of the technical features thereof may be replaced with equivalents. These modifications or replacements do not make the essence of the corresponding technical solution deviate from the scope of the technical solutions in the embodiments of the present invention.

In conclusion, the foregoing descriptions are merely preferred embodiments of the present invention, and all equivalent changes and modifications made in accordance with the patent application scope of the present invention shall fall within the scope covered by the present invention.

What is claimed is:

1. A multi-functional cart frame of an outdoor cart, comprising:
a cart frame body, comprising a bottom frame, a first side frame and a second side frame that are arranged on two sides of the bottom frame along a length direction, and a third side frame and a fourth side frame that are arranged on two sides of the bottom frame along a width direction, wherein the first side frame and the second side frame respectively comprise two bearing vertical rods that are arranged oppositely, and two ends of each of the third side frame and the fourth side frame are connected to the first side frame and the second side frame respectively; and
a movable frame, arranged above the bottom frame in a spaced manner, wherein the movable frame comprises a first seating frame hinged to the first side frame, a second seating frame hinged to the second side frame, and a bridge frame arranged between the first seating frame and the second seating frame; and the first seating frame can be folded and positioned on the first side frame, and the second seating frame can be folded and positioned on the second side frame; and
the bridge frame has an unfolded state in which the bridge frame is connected to the first seating frame and the second seating frame respectively and an accommodated state in which the bridge frame is separated from the first seating frame and/or the second seating frame; in the unfolded state, a first storage layer arranged between the bottom frame and the movable frame and a second storage layer arranged on an upper side of the movable frame are formed between the third side frame and the fourth side frame; and in the accommodated state, a seating region arranged along the first seating frame, the second seating frame, and the bottom frame is formed between the third side frame and the fourth side frame.

2. The cart frame of an outdoor cart according to claim 1, wherein one end of the bridge frame is hinged to the first seating frame and can rotate to be stacked and accommodated on an upper side of the first seating frame, and the other end thereof is separably connected to the second seating frame.

3. The cart frame of an outdoor cart according to claim 2, wherein a first support portion that protrudes towards an interior of the cart frame body and is configured to bear the bridge frame is disposed on the second seating frame, a hanging portion arranged corresponding to the first support portion is disposed on the bridge frame, and the bridge frame rests on the first support portion through the hanging portion to be separably connected to the second seating frame.

4. The cart frame of an outdoor cart according to claim 2, wherein the first seating frame is hinged to the first side frame through a first hinge shaft, a first flipping region allowing the first seating frame and the bridge frame to flip and fold upwards around an axis of the first hinge shaft is formed between the third side frame and the fourth side frame, and a first positioning member configured to position the first seating frame after flipping and folding is disposed on an upper portion of the first side frame or upper portions of the third side frame and the fourth side frame; and
the second seating frame is hinged to the second side frame through a second hinge shaft, a second flipping region allowing the second seating frame to flip and fold upwards around the second hinge shaft is formed between the third side frame and the fourth side frame, and a second positioning member configured to position the second seating frame after flipping and folding is disposed on an upper portion of the second side frame or the upper portions of the third side frame and the fourth side frame.

5. The cart frame of an outdoor cart according to claim 4, wherein the first positioning member comprises a positioning clamping groove I and a positioning clamping groove III arranged back to the positioning clamping groove I, a groove opening of the positioning clamping groove I is arranged towards an interior of the cart frame body, a groove opening of the positioning clamping groove III is arranged towards an exterior of the cart frame body, the positioning clamping groove I is internally provided with a positioning channel I configured to be connected to the first seating frame in a clamping manner, and the positioning clamping groove III is internally provided with a positioning channel III configured to be connected to the bridge frame in a clamping manner;
the second positioning member comprises a positioning clamping groove II, a groove opening of the positioning clamping groove II is arranged towards the interior of the cart frame body, and the positioning clamping groove II is internally provided with a positioning channel II configured to be connected to the second seating frame in a clamping manner; and
the positioning channel I, the positioning channel II, and the positioning channel III are arranged in parallel to the bearing vertical rod.

6. The cart frame of an outdoor cart according to claim 1, wherein the two ends of each of the third side frame and the fourth side frame respectively comprise a first handrail transverse rod connected to the upper portion of the first side frame and a second handrail transverse rod connected to the upper portion of the second side frame, the first handrail transverse rod and the second handrail transverse rod are arranged above the first seating frame and the second seating frame respectively, and the first handrail transverse rod and the second handrail transverse rod are arranged on two sides of the seating region respectively for an occupant to rest a hand when seating in the seating region.

7. The cart frame of an outdoor cart according to claim 6, wherein the first seating frame is connected to the first handrail transverse rod through a cantilever member, an upper end of the cantilever member is hung on the handrail transverse rod, the first seating frame is hung at a lower end of the cantilever member, and the cantilever member is separably connected to the first handrail transverse rod and/or the first seating frame through a hooking structure.

8. The cart frame of an outdoor cart according to claim 7, wherein the first handrail transverse rod is provided with a first connecting shaft and a second connecting shaft, and the second connecting shaft is arranged on one side, close to the first side frame, of the first connecting shaft in a spaced manner; and
one end of the cantilever member is hinged to the first seating frame, and the other end thereof is hinged to the first connecting shaft and forms a first polygonal linkage structure with the first handrail transverse rod, the first side frame, and the first seating frame before the first seating frame is folded and positioned, and can be connected to the second connecting shaft in a positioning manner and form a triangular support structure with the first handrail transverse rod and the first seating frame after the first seating frame is folded and positioned.

9. The cart frame of an outdoor cart according to claim 6, wherein the third side frame and the fourth side frame respectively comprise at least one group of a first crossed rod and a second crossed rod that are hinged to each other, and the first crossed rod is arranged on an inner side of the second crossed rod; one end of the first handrail transverse rod is hinged to the first side frame, and the other end thereof is hinged to an upper end of the first crossed rod; one end of the second handrail transverse rod is hinged to the second side frame, and the other end thereof is hinged to an upper end of the second crossed rod; and the second seating frame is separably lap-jointed to the first crossed rod through a lap-joint member.

10. The cart frame of an outdoor cart according to claim 9, wherein the first crossed rod is provided with a third connecting shaft, and the second handrail transverse rod is provided with a fourth connecting shaft;
a lower end of the first crossed rod is hinged to a lower portion of the second side frame or the bottom frame; and
a linkage arm is further comprised, the linkage arm is separably connected to the first crossed rod and/or the second seating frame through a hooking structure, one end of the linkage arm is hinged to the second seating frame, and the other end thereof is hinged to the third connecting shaft and forms a second polygonal linkage structure with the first crossed rod, the second side frame, and the second seating frame or forms a second polygonal linkage structure with the first crossed rod, the second side frame, the bottom frame, and the second seating frame before the second seating frame is folded and positioned, and can be connected to the fourth connecting shaft in a positioning manner and form a triangular support structure with the second handrail transverse rod and the second seating frame after the second seating frame is folded and positioned.
